(19) United States
(12) Patent Application Publication
(10) Pub. No.: US 2024/0273350 A1
(43) Pub. Date: Aug. 15, 2024

(54) ULTRA-LOW POWER ANALOG NEURAL NETWORKS

(71) Applicant: RUTGERS, THE STATE UNIVERSITY OF NEW JERSEY, New Brunswick, NJ (US)

(72) Inventors: Yung-Ting Hsieh, Piscataway, NJ (US); Dario Pompili, Hillsborough, NJ (US)

(21) Appl. No.: 18/442,811

(22) Filed: Feb. 15, 2024

Related U.S. Application Data
(60) Provisional application No. 63/445,816, filed on Feb. 15, 2023.

(51) Int. Cl. G06N 3/065; G06N 3/049

(52) U.S. Cl. CPC G06N 3/065; G06N 3/049

(57) ABSTRACT

An analog neural network circuit includes at least one fewer layers than a number of expected layers of a neural network such that at least two cycles of feeding back outputs and applying weights occur to complete all the expected layers of the neural network. A control circuit, for example implemented using an analog oscillator, provides timing signals to control signal paths, including a feedback signal path to reuse circuitry of a layer for the at least two cycles. An analog memory is coupled to store an output of the circuitry of the layer. The analog memory is controllably coupled as part of the feedback signal path to the circuitry of the layer.

### CROSS-REFERENCE TO RELATED APPLICATION(S)

This application claims the benefit of U.S. Provisional Patent Application No. 63/445,816, which was filed Feb. 15, 2023.

### GOVERNMENT SUPPORT

This invention was made with government support under Grant No. 1937403 awarded by the National Science Foundation (NSF RTML). The Government has certain rights in the invention.

### BACKGROUND

Recently, the trend of analyzing physiological markers for health tracking using wearable sensors is on the rise. However, due to the small size of these wearables, battery life is of paramount concern both because of user experience and the continuity of monitoring. Unlike heavy mobile devices, which can be packed with powerful batteries, wearable sensors do not as easily accommodate a power source. In order to enable intelligent evaluation of body's physiological data, a noninvasive continuous monitoring of patients with multiple wearable sensors is needed.

The concept of a wearable Wireless Sensor Network (WSN) is central to realizing the continuous monitoring of the body from multiple vantage points, which can yield advantages such as early detection of the onset of several diseases as well as close medical monitoring of people operating in stressful conditions such as astronauts, athletes, pilots, etc., as well as people in general in normal working conditions. However, raw data from wearable sensors is not enough. The raw data should be accompanied by analysis which translates the data into meaningful insight into a person's health. At this point, most of this analysis is done on digital devices, which receive the data collected by these wearable sensors. However, digital devices (themselves and the mechanisms by which to communicate from the wearable to the digital device) contribute to severe energy drain, leading to low-battery-life.

Thus, there is a need for ultra-low power techniques and systems that can perform or assist in analysis of collected data.

### BRIEF SUMMARY

Designs of an ultra-low power analog neural network are described. Ultra-low power devices are suitable for scenarios in which the power being consumed is compatible with that generated by energy harvesting capabilities of the node (e.g., vibration energy harvesting without a battery). A “folded” analog circuit architecture is presented that enables neural network processes to be carried out at a wireless node that performs continuous monitoring with ultra-low power consumption (e.g., on the order of nano- or pico-watts or less). The “folded” analog circuit neural network architecture saves space, which enables the processing capabilities at a small footprint. The analog circuit neural network is considered “folded” as it takes the output and feeds back through the neuron architecture to complete all the layers of the neural network.

An analog neural network circuit includes at least one fewer layers than a number of expected layers of the neural network. The analog neural network circuit further includes a control circuit for providing timing signals to control signal paths, including a feedback signal path to reuse circuitry of a layer for the at least two cycles; and an analog memory coupled to store outputs of the circuitry of the layer, the analog memory controllably coupled as part of the feedback signal path to the circuitry of the layer.

The layers of the analog neural network circuit are each formed of a corresponding plurality of neurons. In some cases, each neuron is implemented by a neuron circuit having an array of resistive processing units (RPUs).

In some cases, the layers of the analog neural network include an input layer, a folded layer providing hidden layers, wherein the folded layer has the circuitry of the layer that is reused for the at least two cycles, and an output layer. The folded layer can be used for implementing hidden layers of a same number of neurons.

A method of operating an analog neural network having an input layer, a folded layer providing hidden layers such that at least two cycles of feeding back outputs and applying weights occur to complete all expected layers of the neural network, an output layer, a control circuit, and an analog memory, can include generating, by the control circuit of the analog neural network, a write control signal, a read control signal, an input control signal, an output control signal, and a weight-change control signal. The write control signal and the read control signal controllably couples the analog memory of the analog neural network as part of a feedback signal path to reuse circuitry of the folded layer. The input control signal couples output of the input layer to the folded layer. The output control signal couples a final output of the folded layer to the output layer. The weight-change control signal controls application of weights to the folded layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment of an ultra-low power analog neural network design approximation for wireless health monitoring.

FIG. 2A illustrates a conceptual diagram of a folded neural network with a feedback loop in accordance with an embodiment of the invention.

FIG. 2B illustrates a block diagram of an implementation of a folded neural network with a feedback loop in accordance with an embodiment of the invention.

FIG. 3A illustrates a conceptual diagram of a neural network with folded hidden layers.

FIG. 3B illustrates a block diagram of an implementation of a neural network with folded hidden layers.

FIGS. 4A-4C show example timing diagrams of control signals such as shown in the neural network implementation of FIG. 3B for operating a folded neural network layer providing two layers (FIG. 4A), three layers (FIG. 4B), and four layers (FIG. 4C).

FIG. 5 shows an example analog memory.

FIG. 6A shows a single voltage-based resistive processing unit (VRPU).

FIG. 6B illustrates an example neuron with two inputs.

FIG. 7A shows an example analog RNN for a bio-sensor.

FIG. 7B shows an example implementation of a neuron for a layer of the analog RNN.

FIG. 7C shows a training scenario.

FIGS. 8A and 8B illustrate one and two layers of an RNN with three nodes/neurons per layer.

FIG. 9 shows an example hybrid analog-digital architecture.

FIG. 10A illustrates a real-time analog signal encoding and compression scheme.

FIG. 10B shows a 2D Shannon mapping (2:1 compression) realized via output characteristics of a MOSFET in saturation region.

FIG. 11 shows the performance of drone anomaly detection in the example of x-axis accelerometer sensor data with the proposed analog design.

### DETAILED DESCRIPTION

Designs of an ultra-low power analog neural network are described. Ultra-low power devices are suitable for scenarios in which the power being consumed is compatible with that generated by energy harvesting capabilities of the node (e.g., vibration energy harvesting without a battery). An analog circuit architecture is presented that enables ultra-low-powered (e.g., on the order of nano- or pico-watts or less) battery-less pre-processing on wearable devices themselves, saving both on power expended on transmission as well as computation performed on central digital nodes. Furthermore, the analog circuit architecture can be implemented with a “folded” design that saves space, which enables the processing capabilities at a small footprint.

The described architecture introduces ‘intelligence’ or processing capabilities to the smaller nodes themselves. These capabilities enable the nodes to pre-process data locally and result in lower-power consumption and communication overhead to perform the same level of monitoring. Furthermore, small all-analog computational architectures consume very low power (on the order of u-Watts), which means that the processing circuitry of the all-analog computation architectures could be powered by harvesting energy from environmental sources, e.g., the patient's own thermal heat or vibrations. This is possible as wearable devices working on thermoelectric principles have been shown to generate power in the order of hundreds of u-Watts, implying that the energy harvesting mechanisms on wearable devices could be used to reliably power computational architectures requiring such low power to operate. Advantageously, by designing sensor nodes that can do sensing and low-level processing by harvesting energy from readily available sources, one can get rid of batteries, leading to further miniaturization (and hence affordability and ease of use) of the sensor nodes.

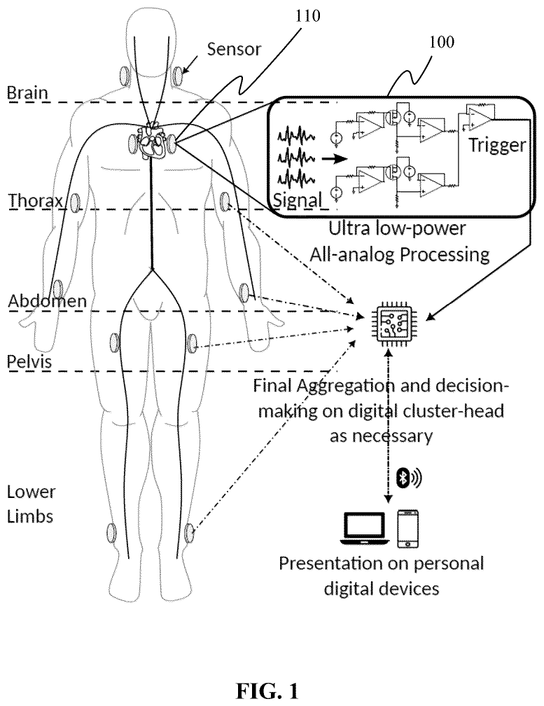

FIG. 1 illustrates an example operating environment of an ultra-low power analog neural network design approximation for wireless health monitoring. Referring to FIG. 1, noninvasive continuous monitoring of physiological signals is performed using multiple wearable sensors and wireless communication infrastructure for communication among different sensor nodes. Through including ultra low-power all-analog processing at sensor nodes (e.g., analog circuitry 100 at sensor node 110), analog pre-processing of physiological signals can be performed at multiple locations with an optional subsequent processing at digital nodes (e.g., final aggregation and decision making, which may be presented on personal digital devices as an example).

Physiological signals are the kinds of signals which are produced by the physiological processes in the body and can be very helpful in understanding the activity of the autonomic nervous system and other organs in general. These signals include but are not limited to blood volume pulse (BVP), electrocardiogram (ECG) and skin conductance level (SCL). The changes in these signals have been linked to the onset of many diseases like congestive heart failure, arrhythmias, sleep apnea, Parkinson's, etc. and even psychological stress in general.

Given this strong relationship between these physiological signals and a variety of medical problems, there is a great interest in both analysis of these signals as well as their sensing. Indeed, a network of wearable sensors can generate data that can be used to rapidly classify a disease from the sensing data.

When analyzing these physiological signals, the time-frequency relationships in the signals are important. Neural networks, including Recurrent Neural Networks (RNNs) such as Long Short Term Memory Networks (LSTMs), are able to be used to model the time-frequency relations in these physiological signals as well as classify the signals for medical applications. By capturing long-term temporal dependencies directly from data, RNN-based approaches have achieved better performance for classifying as well as predicting onset of diseases. However, the analysis of physiological signals is not conducted in isolation; the ability to implement RNN-based approaches should consider the resources spent on the processing, and sensor and processor design. An analog architecture to enable neural network (e.g., RNN or convolutional neural network (CNN)) processing on battery-less low-powered wearable sensors is presented, which can be used to assist in the classification of the onset of a myriad of diseases.

Evaluation of diseases from patients usually follows a standard protocol in a pre-hospital setting. The steps in the standard protocol are prioritized to identify and treat the most life-threatening diseases. These steps include ensuring a patient airway (Airway), verifying adequate ventilation (Breathing) and ECGs from sensors distributed on the body of patient. Currently available monitoring devices that could aid this process include pulse oximetry, capnography, blood pressure measurement, cerebral monitoring, and temperature measurement. These sources of patient information tend to be hard-wired, are independent rather than integrated, have no or only crude approaches for determining out of range values, and are heavily dependent on provider interpretation of values. However, by integrating these sources of data as part of wearable sensors, it is possible to forewarn an oncoming problem. A purpose of such a wearable wireless sensor network is to provide a real-time insight into the relevant factors for the operating conditions of the body, e.g., stress, oxygenation levels, heart rate, etc.

Often a two-tiered approach to wearable sensors is taken where multiple smaller nodes are used to sense physiological response at multiple points on the body and a smaller number of cluster-heads e.g., mobile phones, medical devices, etc. (with suitable processing power) are used to compile the data into sensible, usable information. However, in order to enable intelligent evaluation of a body's physiological data, it can be beneficial to include computation functionality at the sensor nodes so long as the computational components are capable of computation with very low energy cost. The described analog architecture enables computation functionality at the sensor nodes.

An analog design is constrained by the complexity the design can handle, as errors accumulate in the circuit due to small hardware in-efficiencies during processing, and a lack of flexibility since analog circuits are purpose-built for applications they are suited for and are not general purpose. However, in a setting where battery-less computation has a myriad number of advantages, e.g., miniaturization, case-of-use, affordability, etc., an analog design enables on-chip/on node processing as compared to digital architecture, which currently requires hundreds of milli-Watts or higher of power, or even hybrid analog-digital architecture, with currently requires milli-Watts of power.

The pure-analog/all-analog architecture presented herein enables complex neural network (NN)-based analysis on sensor data by serializing computation in a simple analog computational architecture. In addition, the described analog architecture can be used in a flexible way enabling multiple types of computation.

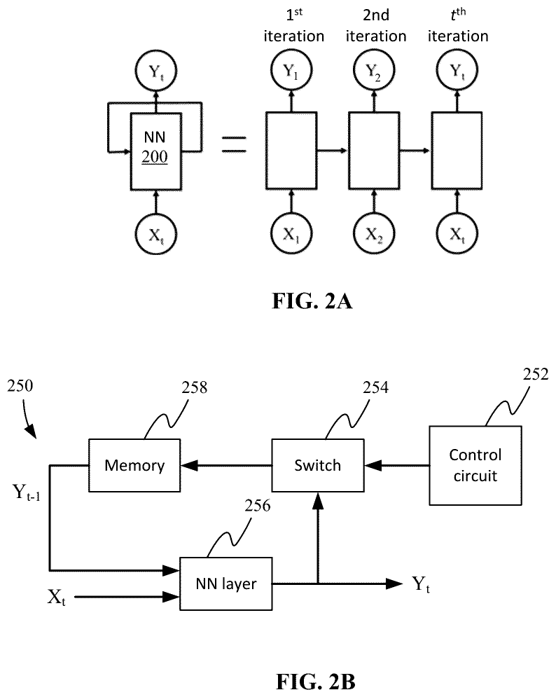

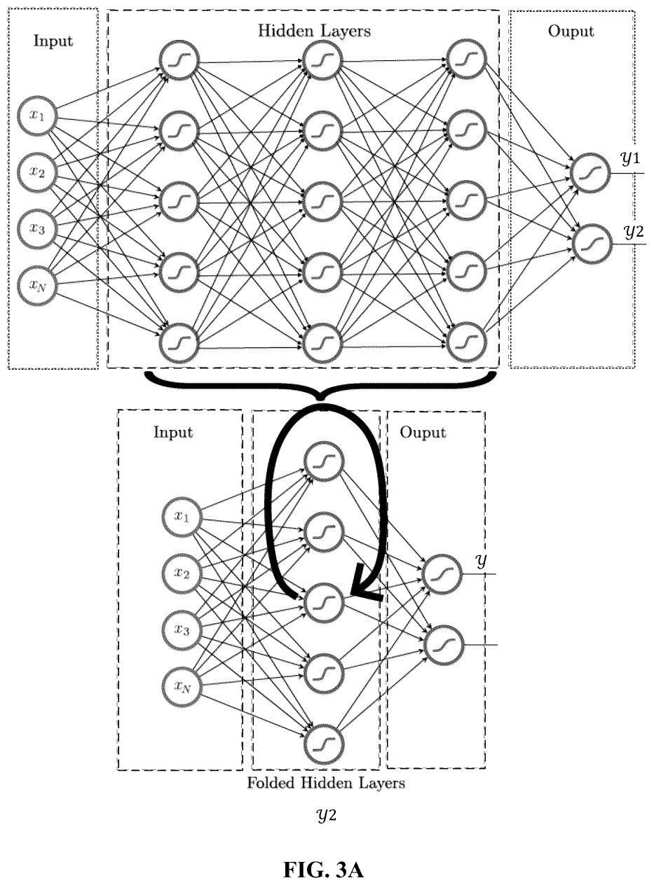

FIG. 2A illustrates a conceptual diagram of a folded neural network with a feedback loop in accordance with an embodiment of the invention; and FIG. 2B illustrates a block diagram of an implementation of a folded neural network with a feedback loop in accordance with an embodiment of the invention. The feedback loop can be unfolded to one time of the forward operation of the Neural Network (NN).

In order to build an analog recurrent network for all analog pre-processing of time-series physiological signals as mentioned above, one challenge is to enable the scenario where new output depends on new input as well as old outputs making it a time-variant system. As shown in FIG. 2A, the NN model 200 (e.g., the neuron) is considered as running repeatably following the time steps on the right unfolded sequence. That is, for a NN with 1 layers (where t=3 is shown but should not be construed as limiting), the neurons in the NN model (which is formed of at least one fewer neuron circuits than expected layers of the NN) are reused but with different weights to complete the processing of an input. For example, for a 12 layer NN, the NN model 200 could have 1, 2, 3, 4, or 6 neurons such that the model 200 is reused a corresponding 12, 6, 4, 3, or 2 times to complete all the layers.

As can be seen, layers of an analog neural network can be “folded” where the folded layer has circuitry of a layer that can be reused for additional layers in order to provide an expected number of layers of the neural network. Advantageously, the folded layer can be used in any neural network architecture where two consecutive layers have a same number of neurons. Examples of such neural network architectures include recurrent neural networks and some convolutional neural networks.

As shown in FIG. 2B, the NN model 200 may be implemented by an analog architecture of analog NN 250 which can feed the block output back to the input. The basic principle of operation of the analog NN 250 is very similar to a finite state machine, which is defined in the digital circuits. Here, a control circuit 252, which can be implemented using an analog oscillator, serves as the clock to control the feedback loop by controlling switch 254. As an example operation, as the switch 254 closes, circuitry of a neural network layer 256 does the forward path calculation with a given window of the input time sequence data Xₜ and results in output Yₜ. The respective windows of these signals are controlled by the control circuit 252. When the switch 254 opens, the output of the NN layer 256 goes to the feedback loop and gets stored in the memory 258, which is designed to have a lower read and write times than the oscillator frequency. As the signal generated by the control circuit 252 continues, when the switch 254 closes for the next time period, the Xₜ₊₁ and Yₜ become new inputs, thus achieving recurrence.

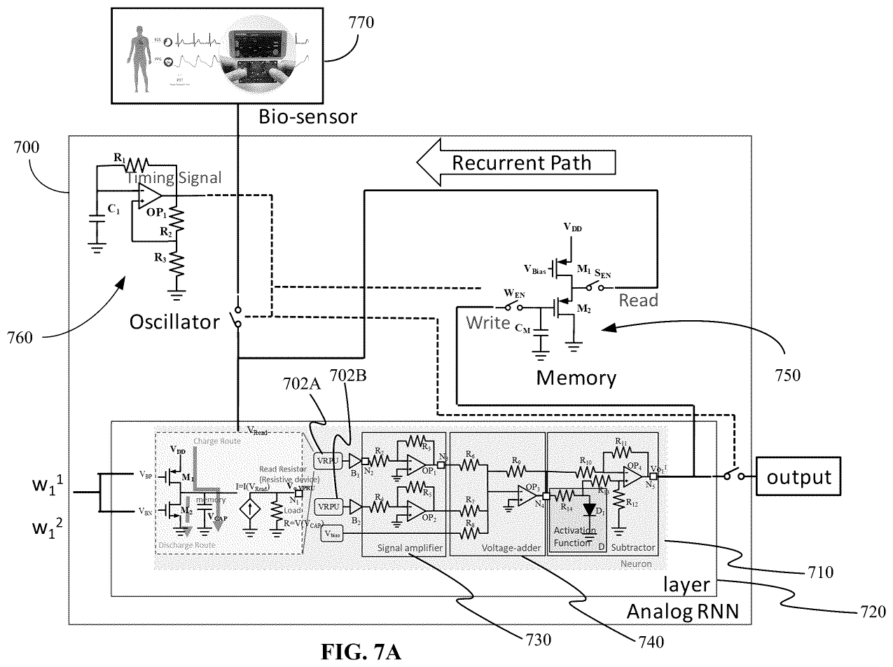

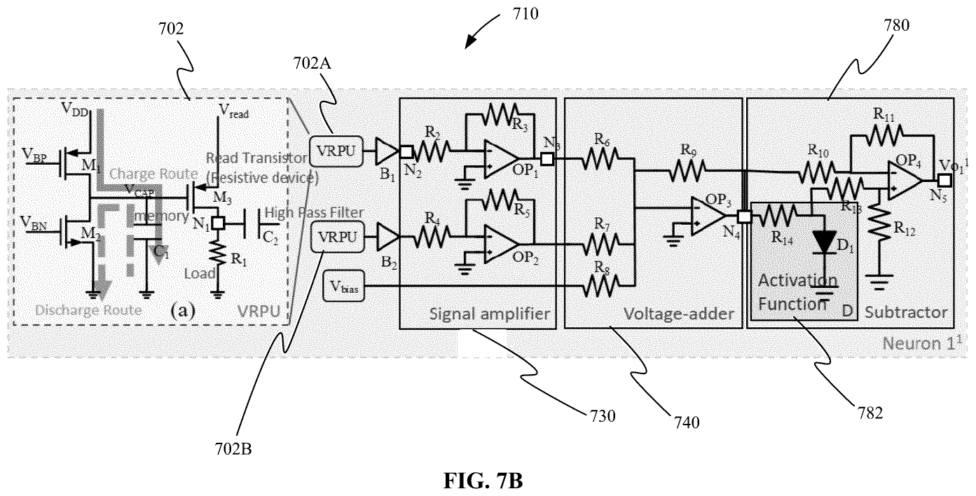

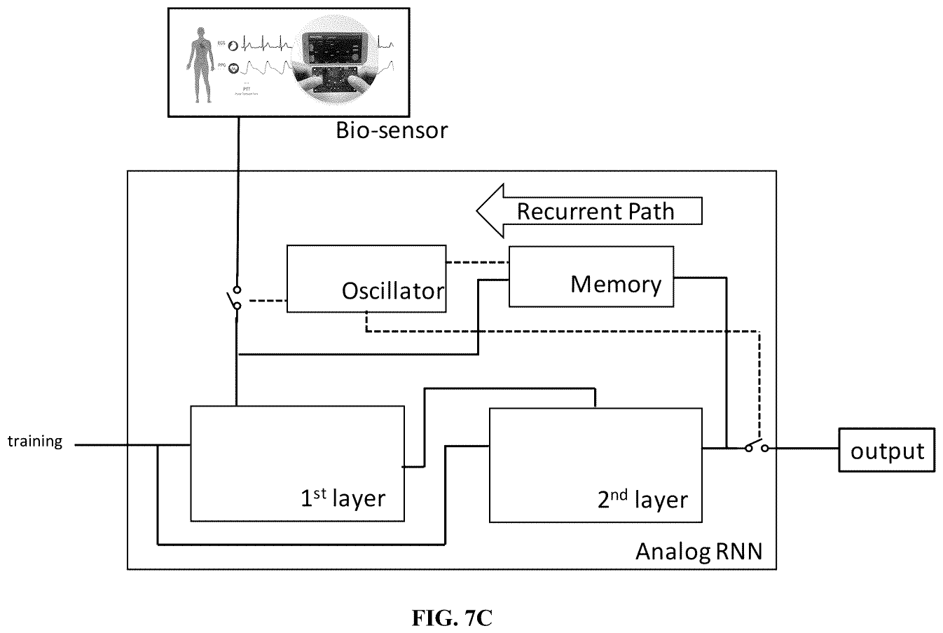

The control circuit 252 can include any suitable oscillator, for example, using an operational amplifier or a crystal. An example oscillator circuit is shown in FIG. 7A.

Switch 254 can be a transistor switch, for example, a field effect transistor. Although one switch is described, other switches may be included for control of a variety of different signal paths.

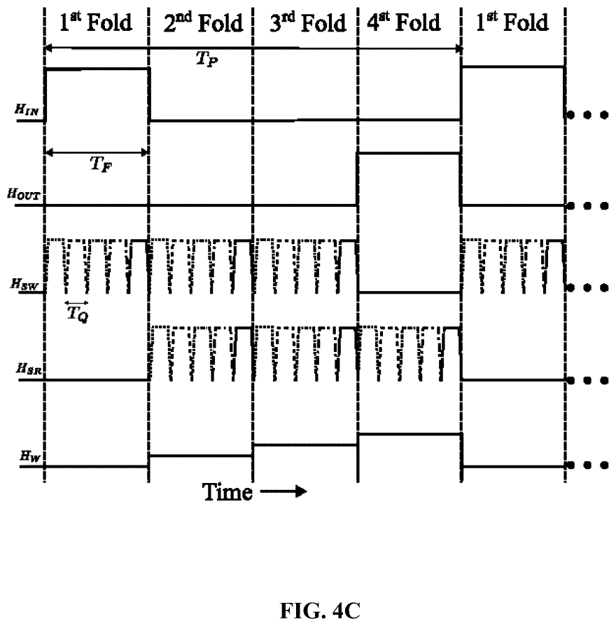

Memory 258 can be any suitable memory, for example, non-volatile based memory. An example implementation of memory 258 is shown in FIG. 5 (an example single unit is shown in FIG. 7A).

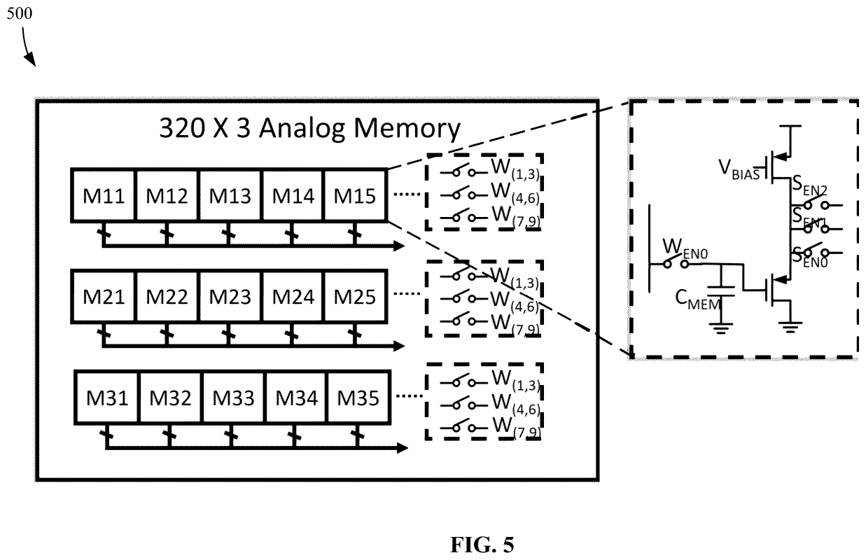

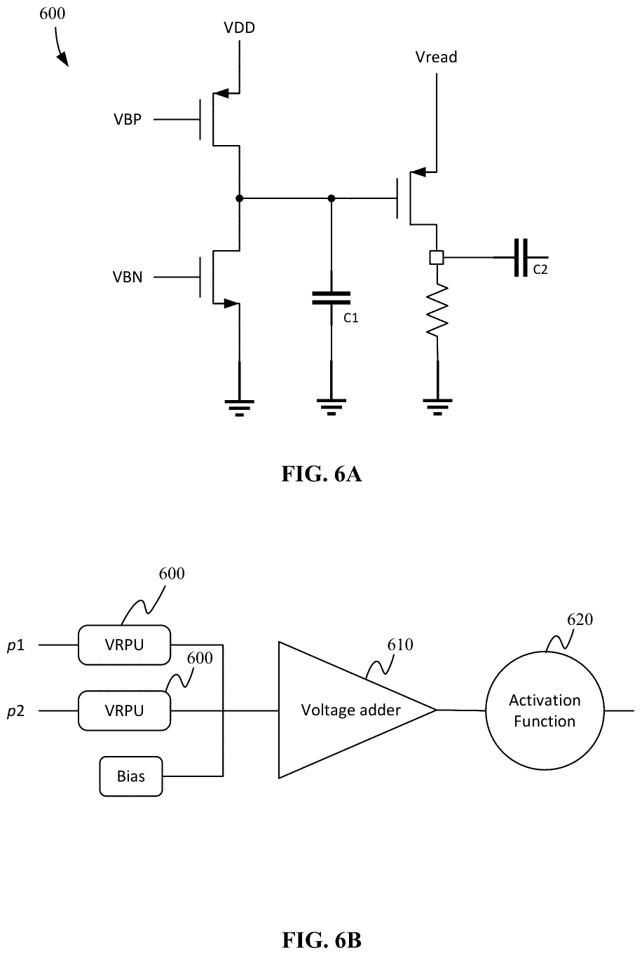

The NN layer 256 can provide one or more neurons. Each neuron can be implemented by a neuron circuit having an array of voltage-based resistive processing units, each configured such as shown in FIG. 6A. Conceptually, a cross-bar array of RPUs have row and column connections. As an implementation of a neuron with the RPU array, voltage-based RPUs are summed via a voltage adder and fed into an activation function circuit such as shown in FIGS. 6B and 7B.

As can be seen, it is possible to implement an analog neural network circuit with at least one fewer layers than a number of expected layers of a neural network such that at least two cycles of feeding back outputs and applying weights occur to complete all the expected layers of the neural network by further including a control circuit 252 for providing timing signals to control signal paths, including a feedback signal path (e.g., through switch 254) to reuse circuitry of a layer (e.g., NN layer 256) for the at least two cycles; and an analog memory 258 coupled to store outputs of the circuitry of the layer 256, the analog memory 258 controllably coupled as part of the feedback signal path to the circuitry of the layer 256 (e.g., at least through switch 254).

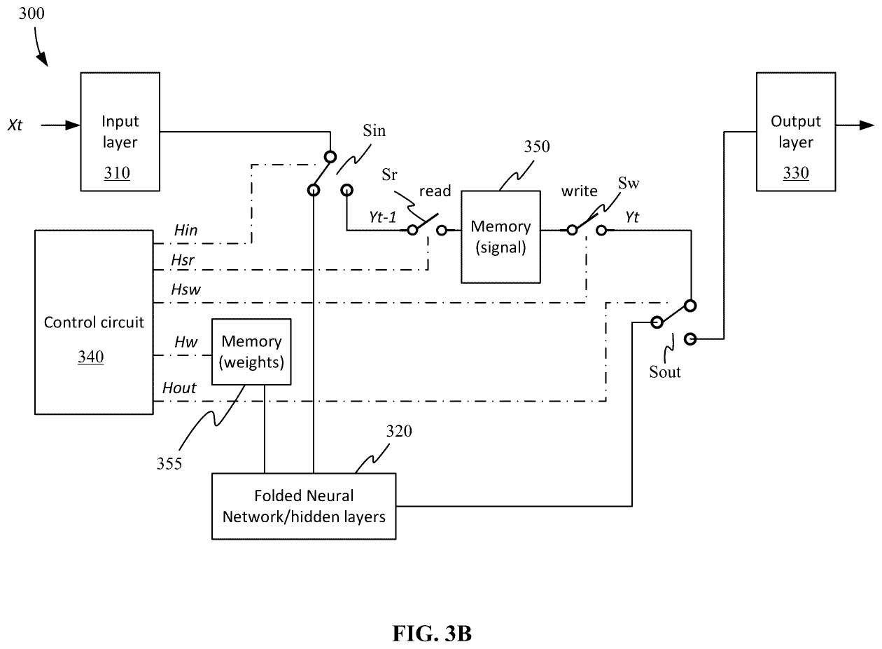

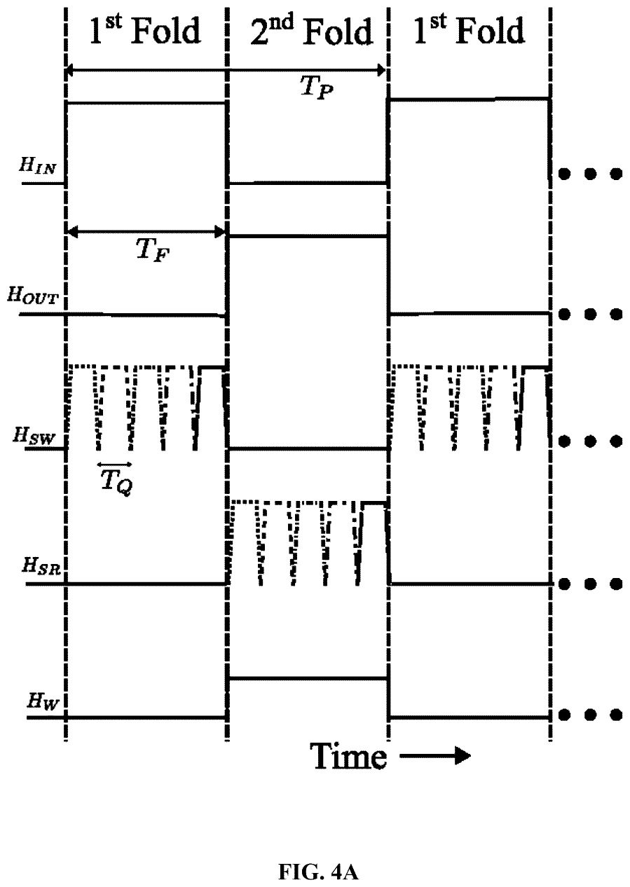

FIG. 3A illustrates a conceptual diagram of a neural network with folded hidden layers. As shown in FIG. 3A, it is possible to have fewer layers of the neural network than expected layers through the use of folded hidden layers. Here, three layers are folded into a single reusable layer, which can be referred to as a folded layer. Then, instead of a circuit with five layers, circuitry of only three layers may be fabricated, where one of the three layers functions as a folded layer in order to functionally operate as five layers. In some cases, circuitry of a single layer may be used to implement all expected layers. In some cases, multiple folded layers may be used.

FIG. 3B illustrates a block diagram of an implementation of a neural network with folded hidden layers. Referring to FIG. 3B, an analog neural network circuit 300 includes an input layer 310, a folded layer 320 providing hidden layers, and an output layer 330. The folded layer 320 results in the analog neural network circuit 300 having at least one fewer layers than a number of expected layers of the neural network such that at least two cycles of feeding back outputs and applying weights occur to complete all the expected layers of the neural network. The analog neural network circuit 300 further includes a control circuit 340 for providing timing signals to control signal paths, including a feedback signal path to reuse circuitry of a layer (e.g., the folded layer 320) for the at least two cycles; and an analog memory 350 coupled to store outputs of the circuitry of the layer. The analog memory 350 is controllably coupled as part of the feedback signal path to the circuitry of the layer. In addition to the analog memory 350 for storing the outputs of the circuitry of the folded layer 320 for feeding back to the folded layer 320, the analog neural network circuit 300 includes a weights memory 355.

The control circuit 340 generates control signals for computation of the hidden layers, including the control signals for controlling the feedback signal path (e.g., across various switches). Here, the control circuit 340 generates a write control signal (Hsw), a read control signal (Hsr), an input control signal (Hin), an output control signal (Hout), and a weight-change control signal (Hw).

In the example implementation, Hin controls the tri-state switch Sin, and is HIGH (connecting to 1^{st} layer output) for the first fold, and LOW (connecting to feedback) for all other folds in a processing cycle. Hout controls the tri-state switch Sout, and is HIGH (connecting to Lth layer input) for the last fold, and LOW (connecting to feedback) for all other folds in a processing cycle. Hsw controls write-operation to signal memory and can be a bus composed of nq signals (corresponding to the number of points that will be sampled from a signal), each controlling an individual capacitor in the memory. The bus writes to nq capacitors sequentially during each fold except the last (when output is directed to the Lth layer input). Similarly, Hsr controls read-operation from signal-memory, and is also a nq-wide bus. The bus reads from capacitors sequentially during each fold except the first (when input is obtained from 1^{st} layer output). Finally, Hw changes between nf discrete levels during the processing window (where nf is the number of folds) to load the weights from the weights memory to the folded network.

Similar to that described with respect to the architecture of FIG. 2B, a neural network layer can be implemented using an array of VRPUs such as shown in FIGS. 6B and 7B. The weights from the weights memory 355 are used to further control the Vp and Vn in the VRPU at the gates of the left two transistors (see VRPU 702 shown in FIGS. 7A and 7B with weights w₁¹ and w₁² to the single neuron). In some cases, the number of weights loaded for one fold can be the number of layers processed per fold multiplied by the width of the folded network (hidden-size) multiplied again by the width of the folded network (hidden size). Since the weights and inputs in the VRPU are voltage-controlled, a capacitor can be used as the basic memory element (see e.g., memory shown in FIGS. 5 and 7A). Both the signal memory and the weights memory can be implemented as arrays of capacitors, which can be read/written by signals from the control circuit.

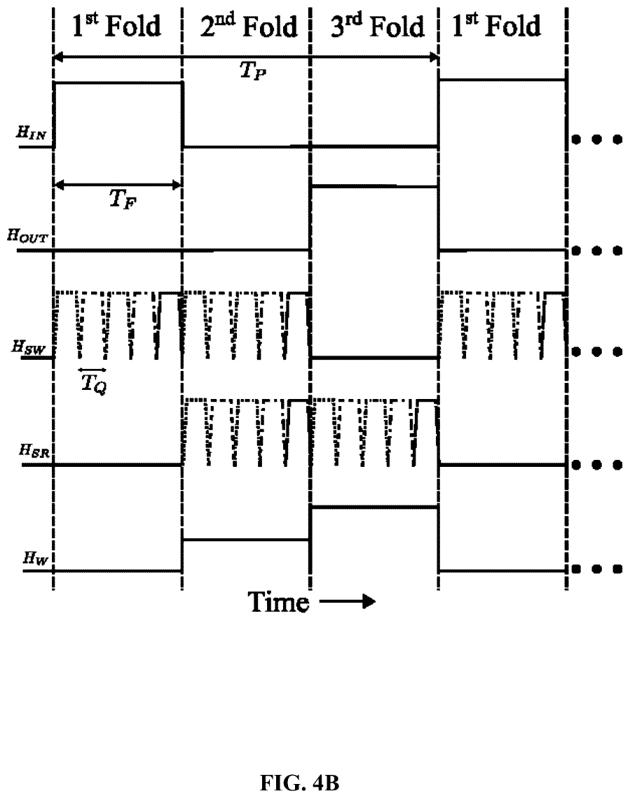

FIGS. 4A-4C show example timing diagrams of control signals such as shown in the neural network implementation of FIG. 3B for operating a folded neural network layer providing two layers (FIG. 4A), three layers (FIG. 4B), and four layers (FIG. 4C). As can be seen from the timing diagrams, the input control signal (Hin) and the output control signal (Hout) have a period equal to a number of layers implemented by the folded layer and a pulse length of an amount of time taken to process a single layer. The input control signal (Hin) is high during a first layer of the hidden layers and low during other layers of the hidden layers. The output control signal (Hout) is high during a last layer of the hidden layers and low during other layers of the hidden layers.

The write control signal (Hsw) provides a sampling frequency of a specified temporal quantization during at least the first layer of the hidden layers and is off during the last layer of the hidden layers, and the read control signal (Hsr) provides the sampling frequency of the specified temporal quantization during at least the last layer of the hidden layers and is off during the first layer of the hidden layers.

The weight-change control signal (Hw) controls the application of weights for each layer's processing time. The weight-change control signal (Hw) can change between discrete levels.

FIG. 5 shows an example analog memory. Memory 500 is designed for storing and releasing analog signals for the purpose of a 3 by 3 matrix multiplication operation, which is connected to an RPU crossbar array (e.g., which can implement a neuron in a NN layer 256). This memory is compatible for a 3 node computation (e.g., where t=3 such as shown in FIG. 2A). Switches can be controlled by a control circuit such as control circuit 252 of FIG. 2B or control circuit 340 of FIG. 3B.

FIG. 6A shows a single voltage-based resistive processing unit (VRPU); and FIG. 6B illustrates an example neuron with two inputs.

Referring to FIG. 6A, a VRPU 600 is composed of three transistors with a capacitor, referred to as a 3TIC structure. In particular, a first PMOS transistor is coupled to receive a weight at its gate; a first NMOS transistor is coupled to receive the weight at its gate (e.g., VBP=VBN=a particular weight) and coupled by its drain to a drain of the first PMOS transistor. A first capacitor is coupled at a first end to the drains of the first NMOS transistor and the first PMOS transistor. A read PMOS transistor is coupled at its gate to the first end of the first capacitor. A load (e.g., resistor) is at a drain of the read PMOS transistor. A high pass filter is at the drain of the read PMOS transistor. In the 3TIC structure, the capacitor is responsible for storing the weights and two transistors as a NMOS and PMOS pair are designed to tune the weight of the capacitor. As the input signal is sent to the drain of the last transistor, the last transistor will multiply the input signal and the voltage on the capacitor to output the current at its source. Rather than directly using the output current, a load is designed (e.g., R1) such that the voltage at the drain of the last transistor can be used. The high pass filter is included to block the DC voltage. The illustrated RPU 600 can be used to perform matrix multiplications at the heart of neural network computation.

Referring to FIG. 6B, in a single neuron structure, multiple VRPU 600 outputs are combined together into a voltage adder 610. Additionally, since the bias term is a direct addition to the output of a neuron, the bias does not need to go through a VRPU and can be directly connected to the voltage adder 610. Thus, for a neuron with two inputs, p1 and p2, the output is computed as:

$${n}_{1}^{1} = {w}_{11}^{1} {p}_{1} {1}_{12}^{1} {p}_{2} + {b}_{1}^{1} .$$

After the voltage adder, a diode-based activation function circuit 620 with non-ideal and non-linear characteristics can be provided, for example, a ReLU or a sigmoid type.

As described above, it is possible to design a fully analog neural network using the RPU crossbar array. The RPU crossbar array can operate from the most basic matrix multiplications, support vector machines to neural networks on the basis of the Ohm's law.

FIG. 7A shows an example analog RNN for a bio-sensor; FIG. 7B shows an example implementation of a neuron for a layer of the analog RNN; and FIG. 7C shows a training scenario. Referring to FIG. 7A, an analog RNN for a bio-sensor can be configured in accordance with the designs shown in FIG. 2B and FIG. 3B. In the illustrative example of an analog RNN 700 of FIGS. 7A and 7B, it can be seen that there are two VRPUs (702A, 702B) to implement each single neuron 710 in a neuron layer 720. A signal amplifier 730 can be included before the voltage adder 740 to amplify the signal from the VRPUs (702A, 702B). During operation, weights (e.g., w₁¹ and w₁²) are applied to the VRPUs (702A, 702B) from memory 750 under timing of the oscillator 760 providing the control circuit (e.g., the timing signal from the oscillator triggers reads and writes to the memory, based on its cycle). Input from the bio-sensor 770 is also provided to the neuron layer 720 under control of the oscillator 760. The inputs and outputs recur as the timing signal (via the oscillator) completes its cycle. The same timing signal may be used for all components.

Referring to FIG. 7B, similar to that described and shown in FIG. 6A, a VRPU 702 (e.g., implementing VRPUs 702A, 702B) includes an adjustable resistor serving as tunable weight and a capacitor to restore the weight value. The resistor can be adjusted by a back-propagated update signal from the peripheral circuit. When triggered by the update signal, the PMOS and NMOS pair modulates the current direction to tune the weight. As can be seen by the schematics of an analog CMOS voltage-based RPU cell (shown as 702), a charge route for increasing VCAP (C1) runs from VDD through M1 to C1, decreasing conductance of Rm3; and a discharge route for decreasing VCAP (C1) runs from C1 down through M2 to the lower rail/ground, increasing conductance of RM3. The capacitor C2 is serving as a high-pass filter to block the DC to ensure M3 is working at the triode mode and at the same time gives the go-ahead to the intended signal. A signal amplifier 730, voltage adder 740, and subtractor 780 with activation function 782 completes an artificial neuron structure of a single neuron 710 composed of the Voltage-based RPUs and bias 790 with a diode serving as activation function 782.

Referring to FIG. 7C, to train the analog RNN 700, the first step is to establish the same RNN model, which has the same number of neuron and same layer structures with software on the computer. After getting the model trained, the parameters of the model including weights and biases will be imported into the analog circuit through the charge and discharge paths in the RPUs. Various possible implementations of the architecture have engineering tradeoffs involving the build up of noise, time synchronization issues, processing delay, energy, etc. The tradeoffs can be evaluated offline during training/weights generation for optimal synthesis based on the application requirements. In the configuration shown in FIG. 7C, an RNN is presented with 2 layers and the recurrent path.

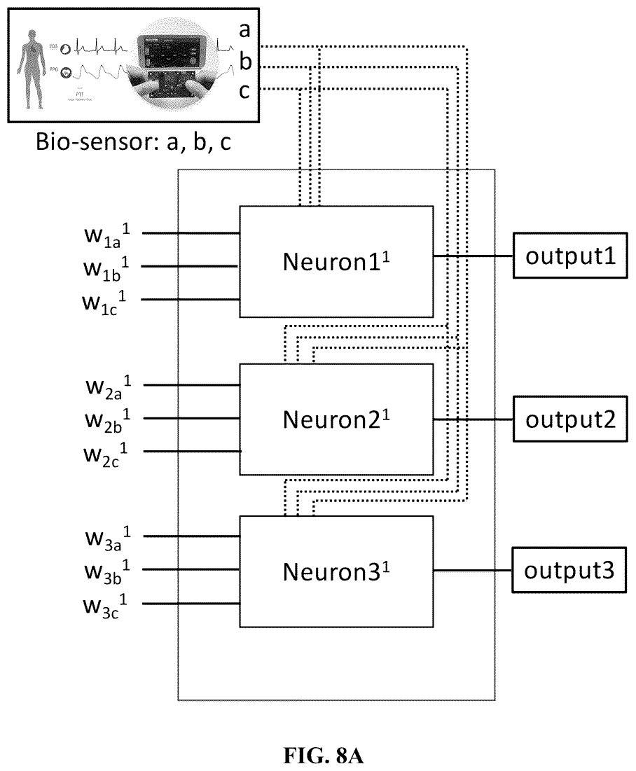

FIGS. 8A and 8B illustrate one and two layers of an RNN with three nodes/neurons per layer. As can be seen, a core RNN layer has 3 nodes (Neuron 1-1, 2-1, and 3-1) that can be controlled via the timing signal, generating inputs and outputs, which recur as the timing signal completes its cycle. The example of FIG. 8A shows 1 layer with three neurons on each layer; and the example of FIG. 8B shows 2 layers with three neurons on each layer.

As previously mentioned above with respect to FIG. 2A, the numbers of layers and neurons are just examples, chosen for the sake of simplicity in drawing the figures. The solution generalizes to any NN size (by “folding” via multiple passes to save space and reduce complexity/energy), e.g., in order to implement a 12-layer, 10-neuron NN, it is possible to perform 3 passes of a 4-layer, 10-neuron NN or alternatively 4 passes of a 3-layer, 10-neuron NN, with the weights optimized offline via training on a computer.

The advantages of the all-analog approach which includes a core RPU array for computation and a timing setup for serializing the computation in time are manifold: i) It performs as a natural extension of time-dimension unrolling operation for RNNs and achieves the computation of RNN by reusing layers or weights leading to low power consumption, and ii) It can be seen as an efficient accelerator for neural networks other than RNNs, where multiple layers of a neural network can be simulated by doing multiple passes of a single core layer matrix multiplication RPU array. In this case, however, new weights for the layers would have to be reloaded as well as the oscillator completes its cycle, but no new inputs would be needed, with computation only based on the recurrence. Hence, this could perform as a general purpose but light-weight accelerator for neural network execution in analog domain. At this time, one of the limitations on the number of layers that can be achieved using a 1-layer RPU array is the noise due to the same signals being passed through the RPU array.

There are numerous different physiological signals that can be acquired from wearable sensors and processed at a sensor node. Indeed, the described architecture can be used for multiple types of physiological signals in an ultra-low-powered setting. For example, the described architecture can be used for wearable sensing of various physiological signals including, but not limited to, non-invasive automated blood pressure measurement, heart rate and cardiac electric activity, respiratory function, oxygen saturation, muscle electric activities, and photoplethysmography/peripheral circulation.

Non-invasive automated blood pressure measurement can be performed using the oscillometric method. The oscillometric method is most useful for systolic and mean blood pressure detection (where the maximum oscillation in a cuff pressure corresponds to mean blood pressure). Thus, the oscillometric method may be most beneficial to use when the entire blood pressure waveform is not required.

Heart rate and cardiac electric activity can be detected using silver-silver chloride (Ag/AgCl) electrocardiogram (ECG) surface electrodes that are attached to a patient's limbs in the Standard Lead configuration. The Lead I, II, and III ECG signals are continuously monitored and amplified. The ECG signal is also be filtered by a bandpass filter set at amplitude cutoff frequencies between 0.1 and 100 Hz.

Respiratory function can be detected using a lightweight strain-gage-based respiratory pressure sensor that is attached to a nostril for monitoring inspiratory and expiratory pressures and respiratory rate. The respiratory volume is measured using a pneumatic belt placed around the rib cage. These sensors allow measurement of the pressure-volume relation for assessment of overall respiratory function.

Oxygen saturation can be measured using a pulse oximeter that can be mounted to either the index finger or the ear lobe to measure oxygen saturation. This existing technology provides an estimate of the percentage of oxygen saturation at the site of measurement, e.g., index finger or ear lobe.

Muscle electric activities can be detected using electromyogram (EMG)-based recording electrodes placed to monitor the patient's action potential conduction and propagation at or near anatomic injury sites. Integrated signals can be tracked to infer severity of muscular or neural abnormalities.

An easy-to-use lightweight optical photoplethysmograph (PPG) can be placed on the finger to provide information about the peripheral circulation.

As mentioned above, the concept of a wearable Wireless Sensor Network (WSN) is central to realizing the continuous monitoring of the body from multiple vantage points, which can yield advantages such as early detection of the onset of several diseases as well as close medical monitoring of people operating in stressful conditions such as astronauts, athletes, pilots, etc., as well as people in general in normal working conditions. In this paradigm, continuous monitoring and biomarker fusion are of paramount importance as several sensors are placed at multiple points recording multiple biomarkers.

### Stress and ECG Signal Example

The following illustrative scenario describes a WSN that targets stress, which is a factor affecting physical and mental well-being. While some moderate levels of stress may be beneficial—e.g., stress helps meet daily challenges, motivates to reach goals and accomplish tasks-high stress can significantly impair the ability to perform tasks and to make rational decisions, which can be detrimental. Furthermore, it has also been documented that even teams or individuals possessing high talent are not safe from the deleterious effects of high stress. In the case of teams, talent facilitates performance only up to a point, after which the benefits of more talent decrease and eventually become detrimental as intra-team coordination suffers. Hence, there is a need to monitor stress levels and use them to maintain and increase both individual and team productivity.

Real-time stress detection and quantification can be an invaluable tool that provides one with increased visibility into and control over the individual's or team's performance, productive capacity, and behavioral patterns. Productivity can be increased by making informed decisions about team composition, hierarchy, and member well-being. Such high-level decisions, in turn, depend upon individual data, which could be used to model the propagation of stress in between individuals working in close proximity or towards a common goal, e.g., in a workplace or during an ongoing surgery. As an example, consider a scenario in which a team has to be formed for a task: the employees who can perform tasks without being overwhelmed by those at higher ranks, or by the anxiogenic behavior of other team members, should be selected. Furthermore, real-time aspects could be used to allow dynamic team hierarchies where people who are in better conditions in the field (e.g., less stressed) are put in charge of the situation, while people who have a high level of stress or induce stress on others are provided help.

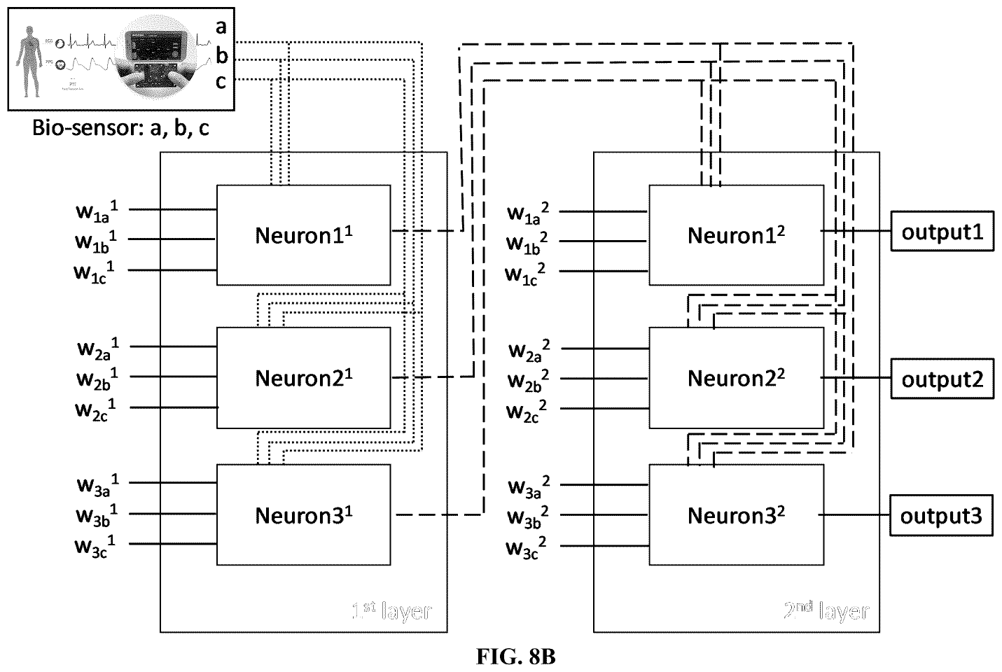

To enable the above-mentioned high-level decision making, applications such as mood- and stress detection, alertness and sleep-quality assessment, are implemented first. Analog sensors installed in spatially key positions around the body can help observe different biomarkers as well as the same biomarkers from different vantage points. In general, these biomarkers and physiological signals consist of both invasive and non-invasive measurements. For example, cortisol, I16, TNF-α, and adrenaline can be considered biomarkers (invasive sensor data) and evaluated with two complementary physiological signals, namely, Galvanic Skin Response (GSR) and Electrocardiogram (ECG), which can be monitored non-invasively and continuously. Following the operating environment shown in FIG. 1, continuous assessment of mood and stress is done at the individual sensor nodes using ultra-low-power all-analog Machine Learning (ML). Later, if such local assessment points to high stress or anomalous mood, a power-hungry digital node can be used to fuse multimodal data from multiple sensors, resulting in the inference of real-time stress detection and quantification. Finally, the results can be displayed on personal digital devices for feedback. An example of this hybrid analog-digital architecture is shown in FIG. 9. As shown in FIG. 9, raw sensor data can be compressed or used directly by either the analog processing component or the digital processing component. Certain classification processes can be carried out in the analog domain and used to trigger the higher energy consuming digital processing chip (that can include an analog to digital circuit and its own processing/neural network).

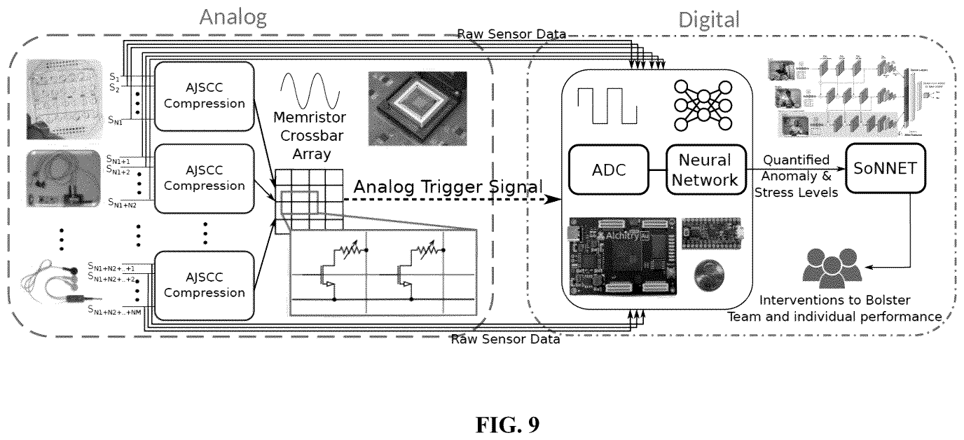

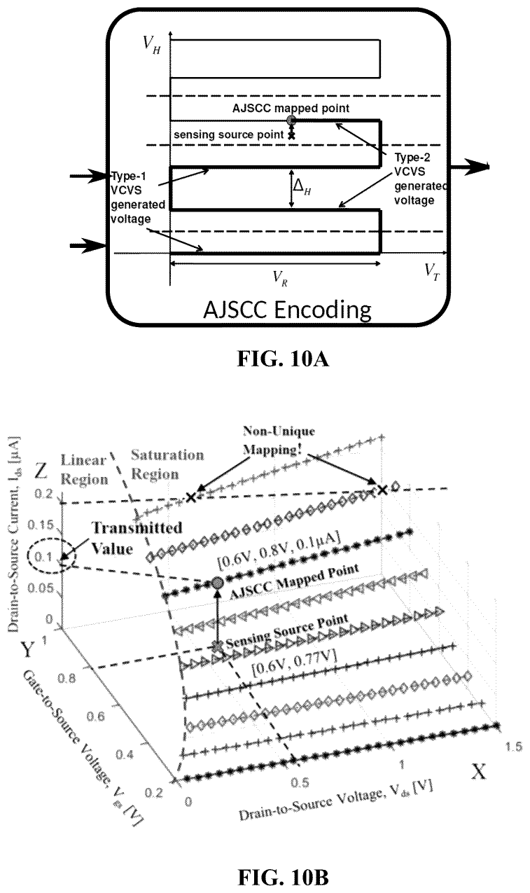

FIG. 10A illustrates a real-time analog signal encoding and compression scheme. At individual sensor nodes, it is possible to perform an energy-efficient multi-sensor signal compression technique using a low-complexity circuit realization in the analog domain. The compressed signals can be given as input to the analog neural network (e.g., the analog RNN shown in FIGS. 7C, 8A, and 8B).

Returning to the stress evaluation scenario, there are multiple concurrent time-series sensing data measurements; for example, the invasive Cortisol biomarker measurements and the non-invasive Electrocardiogram (ECG), that need to be processed together (e.g., via ML models) to estimate the stress levels of an individual. In order to perform this on a wearable device, the inference of ML models should be able to run in real time and in an energy-efficient manner. Hence, a compression technique to compress the sensor data in the analog domain is presented called Analog Joint Source-Channel Coding (AJSCC), which compresses two or more analog signals into one with controlled distortion. AJSCC requires simple compression and coding and low-complexity decoding. AJSCC adopts Shannon mapping as its encoding method. Such mapping, in which the design of rectangular (parallel) lines that can be used for 2:1 compression, was first introduced in C. E. Shannon's seminal paper, “Communication In The Presence of Noise,” (Proceedings of the IRE, 1949), and was later extended to a spiral type as well as to N:1 mapping by G. Brante, et al. in “Spatial Diversity Using Analog Joint Source Channel Coding in Wireless Channels,” (Communications, IEEE Transactions on, vol. 61, no. 1, pp. 301-311, jan 2013). In rectangular mapping, to compress the source signals (“sensing source point”), such as two voltages (VT, VH), the point on the space-filling curve with minimum Euclidean distance from the source point is chosen (“AJSCC mapped point”) via a simple projection on the curve. The compressed signal is the “accumulated length” of the lines from the origin to the mapped point.

Referring to FIG. 10A, an AJSCC can be implemented by Application Specific Integrated Circuits (ASICs), which can take any two analog measurements as input and produces AJSCC output voltage. This circuit is realized using linear (type-1) and inversely linear (type-2) Voltage Controlled Voltage Sources (VCVS) for even- and odd-numbered parallel lines, respectively. Example analog-based AJSCC circuits are described in “Low-power All-analog Circuit for Rectangular-type Analog Joint Source Channel Coding,” by X. Zhao et al., (2016 IEEE International Symposium on Circuits and Systems (ISCAS), Montreal, QC, Canada, 2016, pp. 1410-1413), which is hereby incorporated by reference in its entirety.

Another implementation of an AJSCC can be carried out by exploiting nonlinear properties inherent to analog semiconductor devices, e.g., using the IV (current-voltage) characteristics of a MOSFET as the space-filling curve for achieving a unique mapping of an AJSCC-encoded value (instead of using rectangular parallel lines).

FIG. 10B shows a 2D Shannon mapping (2:1 compression) realized via output characteristics of a MOSFET in saturation region, which can be used for implementing an AJSCC. Referring to FIG. 10B, output characteristics of Ids vs. Vds for different Vgs of a MOSFET in saturation region can be used for the space-filling curve of an AJSCC. The Ids curves in the saturation region to the right of the dashed line (linear region curves are not drawn for clarity), were generated via SPICE, where Vgs is varied in the discrete set, 0.2, 0.3, . . . , 1 V (28 nm Silicon technology MOSFET is used for illustration purpose). The Ids encodes the values of Vgs and Vds (as opposed to extracting the length of the curve from the origin to the mapped point. These saturation region characteristics of a MOSFET can be used with Channel Length Modulation (CLM) to fill the space, where Ids encodes the values of Vgs and Vds. Although there can exist a non-unique mapping in this technique, it may be possible to determine appropriate Vgs, possibly using past Ids data. In such FET-based realization of AJSCC, it is possible to combine multiple FETs to realize high number of AJSCC levels without loss in decoding accuracy; and be robust to environmental variations. This can bring power consumption down to a few mW making this approach ultra-low-power. Example circuitry is described in detail in “Towards Ultra-low-power Realization of Analog Joint Source-Channel Coding using MOSFETs” by V. Sadhu, et al. (2019 IEEE International Symposium on Circuits and Systems (ISCAS), 1-5), which is hereby incorporated by reference in its entirety.

Other space filling curves may be used in alternative implementations, such as Euler, Fermat, and logarithmic spirals, non-circular spirals such as rectangular/hexagonal/octagonal spirals; and space-filling curves for higher dimensions, e.g., spring/recursive structures in addition to 3D ‘ball of yarn’ structure.

As shown in FIG. 9 an AJSCC encoded signal can be processed for real-time energy-efficient inferencing on analog hardware for stress detection. Matrix multiplication can be realized by a memristor crossbar array in analog circuits. The basic principle of crossbar array is that the current is equal to the voltage multiplied by the conductance. In the ML context, the conductance represents weights in the NN and the summation of the current is the summation of the weighted inputs. A memristor crossbar array can efficiently realize these functions based on Kirchhoff's and Ohm's current laws. A voltage-based resistive processing unit (VRPU) is provided for implementing neurons in the analog domain.

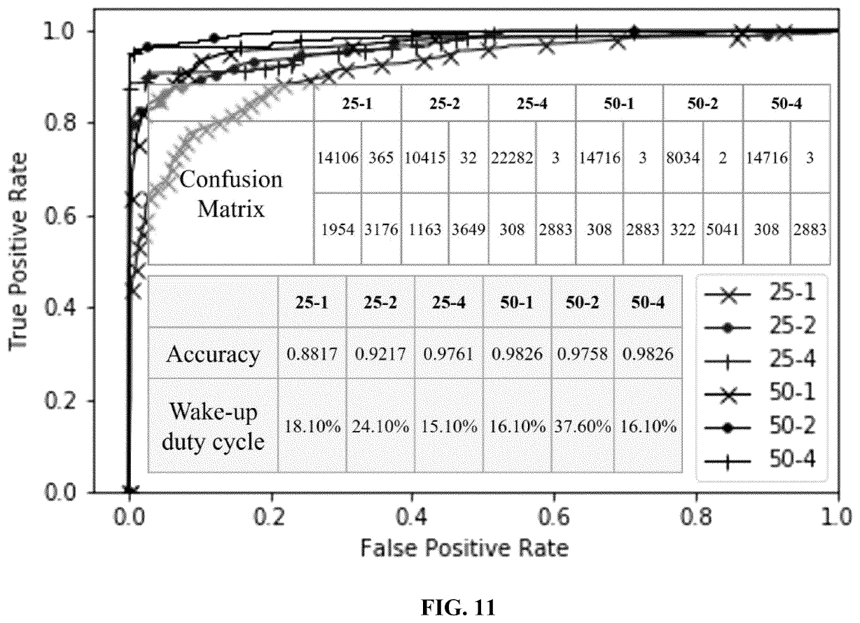

For the system level, an adaptively tunable/re-trainable memristive circuit can be used to have very low FNs anomaly detection. FIG. 11 shows the performance of drone anomaly detection in the example of x-axis accelerometer sensor data with the proposed analog design. Referring to FIG. 11, a Receiver Operating Characteristic (ROC) curve of anomaly detection on drones of 6 datasets for x-coordinates, with window sizes of 25, 50 time-steps and thruster failures of 1, 2, and 4, at max sampling rate of 100 Hz is shown. Embedded tables show the confusion matrix, accuracy, and wake-up duty cycle. As for operating analog ML, the PMOS in VRPU is approximately taking 10 pW. Our 1-Layer VRPU-based network consisting of 24 neurons requires 960 pW of power for VRPUs for ECG classification. The overall power consumption is on the basis of the number of neurons per layer and the number of layers. In bio-sensing, our research team demonstrated the feasibility of operating a recurrent NN to classify diseases with ECG public dataset.

### Performance Evaluation

The analog circuits were simulated with LTSPICE including the electrical property of oscillator, memory and RPUs. The RNN was then evaluated with MATLAB by setting proper parameters we acquire from the LTSPICE. In the proposed analog RNN, the oscillator is serving as the heart to trigger iteration of the network operation. In the analog RNN design, a square wave oscillator composed of a positive feedback amplifier is considered. In the positive feedback loop, the input signal of the amplifier Vi is the summation of the input signal Vₛ and feedback signal V_{f}

$${A}_{f} = \frac{{V}_{0}}{{V}_{s}} = \frac{A}{1 - β A} , \qquad ( 1 )$$

where A is the multiplying factor of the amplifier. β is the multiplying factor of the feedback loop. In the OP amplifier square wave oscillator circuit, the frequency of the square wave is decided by the RC charge and discharge time, the frequency f can be expressed as,

$$f = \frac{1}{T} = \frac{1}{2 RC ln \frac{1 + β}{1 - β}} , \qquad ( 2 )$$

where T in the period of the output signal of the oscillator. As the analog oscillator is low demand in power, the analog circuits have some limitation as providing the high speed flip-flop. In the simulations, it was found that when the frequency of the square wave was enhanced by replacing the smaller capacitor, the distortion become severe. The distortion will cause the sequence problem if it cannot match the RC charge and discharge time of the circuit in the memory, which generate error and noise into the output signal. If there is too much noise, the RNN errors can be detrimental. As the oscillator is being used as a system for switching the past inputs and outputs and to new inputs and outputs, the optimal performance for this part can be important. If the distortion is present in the oscillator due to increased frequency (faster processing), it was observed that due to slower memory access or switching time, it is possible that the device may fail to store the new outputs into memory, and hence, new outputs may not be propagated into the input node as new input value comes in. This will adversely affect the RNN performance and hence there is a trade-off between the RNN performance and the speed at which the computation occurs. It can be important to find an oscillator frequency (related to network processing speed) with minimum distortions so as to get the best performance.

To test and validate the proposed analog RNN, the datasets published under physionet 2020 challenge for classification of 12 lead ECGs were used. In this data set, the ECGs are collected via PTB prototype recorder and is composed of 12 ECG signals. The recorder has 16 input channels, 14 for ECGs, 1 for respiration, 1 for line voltage. The architecture of the RNN that was subject to the test and validation consists of 200 LSTM cells with an embedding dimension of 500. A window size of 25 was used and the LSTM layer was followed with a softmax layer of 27 elements corresponding to the total 27 classes in the dataset. It should be noted that the dataset used in this study for the diagnoses is inherently imbalanced with ‘sinus rhythm’ being the most common diagnosis meaning a healthy ECG, while others are also unequally distributed. In the task of classification, such imbalance between classes can make the classifier biased. While a biased classifier maybe considered a good model if its biases correspond to the natural frequency of occurrence of a disease. However, in learning models, severe imbalances in training usually hinder the learning process and result in subpar classifier. In order to remedy this, importance scores were used for each class, giving higher weights to the loss for minority classes and lower weights to the majority classes.

In the performance simulation, it was found that the RNN achieved a good-enough performance on predicting the diagnoses of various types using ECG signals.

Accordingly, as described herein, a wearable device can be provided that includes one or more sensors for capturing physiological signals; and an analog neural network circuit coupled to receive output of the one or more sensors. The analog neural network circuit can be implemented as described herein. For example, the analog neural network circuit can include at least one fewer layers than a number of expected layers of the neural network such that at least two cycles of feeding back outputs and applying weights occur to complete all the expected layers of the neural network; a control circuit for providing timing signals to control signal paths, including a feedback signal path to reuse circuitry of a layer for the at least two cycles; and an analog memory coupled to store outputs of the circuitry of the layer, the analog memory controllably coupled as part of the feedback signal path to the circuitry of the layer. In some cases, the layers of the analog neural network circuit are each formed of a corresponding plurality of neurons, wherein each neuron is implemented by a neuron circuit comprising an array of resistive processing units (RPUs). As part of the wearable device, an Analog Joint Source-Channel Coding (AJSCC) can be coupled to the one or more sensors, where the RPUs of the neuron circuit are coupled to receive an output of the AJSCC as an initial input for processing.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. An analog neural network circuit comprising:
at least one fewer layers than a number of expected layers of a neural network such that at least two cycles of feeding back outputs and applying weights occur to complete all the expected layers of the neural network;
a control circuit for providing timing signals to control signal paths, including a feedback signal path to reuse circuitry of a layer for the at least two cycles; and
an analog memory coupled to store outputs of the circuitry of the layer, the analog memory controllably coupled as part of the feedback signal path to the circuitry of the layer.

2. The analog neural network circuit of claim 1, wherein the layers of the analog neural network circuit comprise at least two consecutive expected layers having a same number of neurons.

3. The analog neural network circuit of claim 1, wherein the analog neural network circuit provides a recurrent neural network.

4. The analog neural network circuit of claim 1, wherein the control circuit comprises an oscillator.

5. The analog neural network circuit of claim 1, wherein the layers of the analog neural network circuit comprise:
an input layer;
a folded layer providing hidden layers, wherein the folded layer comprises the circuitry of the layer that is reused for the at least two cycles; and
an output layer.

6. The analog neural network circuit of claim 5, wherein the control circuit generates a write control signal, a read control signal, an input control signal, an output control signal, and a weight-change control signal, wherein the write control signal and the read control signal controllably couples the analog memory as part of the feedback signal path, wherein the input control signal couples output of the input layer to the folded layer, wherein the output control signal couples a final output of the folded layer to the output layer, and the weight-change control signal controls application of weights to the folded layer.

7. The analog neural network circuit of claim 6, wherein the input control signal and the output control signal have a period equal to a number of layers implemented by the folded layer and a pulse length of an amount of time taken to process a single layer, wherein the input control signal is high during a first layer of the hidden layers and low during other layers of the hidden layers, wherein the output control signal is high during a last layer of the hidden layers and low during other layers of the hidden layers;
wherein the write control signal provides a sampling frequency of a specified temporal quantization during at least the first layer of the hidden layers and is off during the last layer of the hidden layers; and
wherein the read control signal provides the sampling frequency of the specified temporal quantization during at least the last layer of the hidden layers and is off during the first layer of the hidden layers.

8. The analog neural network circuit of claim 1, wherein the layers of the analog neural network circuit are each formed of a corresponding plurality of neurons, wherein each neuron is implemented by a neuron circuit comprising an array of resistive processing units (RPUs).

9. The analog neural network circuit of claim 8, wherein each neuron circuit further comprises:
a voltage adder coupled to receive outputs of the array of RPUs and a bias; and
an activation function.

10. The analog neural network circuit of claim 9, wherein the activation function comprises a diode.

11. The analog neural network circuit of claim 8, wherein each RPU comprises:
a first PMOS transistor coupled to receive a weight at its gate;
a first NMOS transistor coupled to receive the weight at its gate and coupled by its drain to a drain of the first PMOS transistor;
a first capacitor coupled at a first end to the drains of the first NMOS transistor and the first PMOS transistor;
a read PMOS transistor coupled at its gate to the first end of the first capacitor;
a load at a drain of the read PMOS transistor; and
a high pass filter at the drain of the read PMOS transistor.

12. The analog neural network circuit of claim 8, further comprising:
Analog Joint Source-Channel Coding (AJSCC), the RPUs coupled to receive an output of the AJSCC as an initial input for processing.

13. A wearable device comprising:
one or more sensors for capturing physiological signals; and
an analog neural network circuit coupled to receive output of the one or more sensors, wherein the analog neural network circuit comprises:
at least one fewer layers than a number of expected layers of a neural network such that at least two cycles of feeding back outputs and applying weights occur to complete all the expected layers of the neural network;
a control circuit for providing timing signals to control signal paths, including a feedback signal path to reuse circuitry of a layer for the at least two cycles; and
an analog memory coupled to store outputs of the circuitry of the layer, the analog memory controllably coupled as part of the feedback signal path to the circuitry of the layer.

14. The wearable device of claim 13, wherein the layers of the analog neural network circuit comprise:
an input layer;
a folded layer providing hidden layers, wherein the folded layer comprises the circuitry of the layer that is reused for the at least two cycles; and
an output layer.

15. The wearable device of claim 14, wherein the control circuit generates a write control signal, a read control signal, an input control signal, an output control signal, and a weight-change control signal, wherein the write control signal and the read control signal controllably couples the analog memory as part of the feedback signal path, wherein the input control signal couples output of the input layer to the folded layer, wherein the output control signal couples a final output of the folded layer to the output layer, and the weight-change control signal controls application of weights to the folded layer.

16. The wearable device of claim 15, wherein the input control signal and the output control signal have a period equal to a number of layers implemented by the folded layer and a pulse length of an amount of time taken to process a single layer, wherein the input control signal is high during a first layer of the hidden layers and low during other layers of the hidden layers, wherein the output control signal is high during a last layer of the hidden layers and low during other layers of the hidden layers;
wherein the write control signal provides a sampling frequency of a specified temporal quantization during at least the first layer of the hidden layers and is off during the last layer of the hidden layers; and
wherein the read control signal provides the sampling frequency of the specified temporal quantization during at least the last layer of the hidden layers and is off during the first layer of the hidden layers.

17. The wearable device of claim 13, wherein the layers of the analog neural network circuit are each formed of a corresponding plurality of neurons, wherein each neuron is implemented by a neuron circuit comprising an array of resistive processing units (RPUs).

18. The wearable device of claim 17, further comprising:
Analog Joint Source-Channel Coding (AJSCC) coupled to the one or more sensors, the RPUs coupled to receive an output of the AJSCC as an initial input for processing.

19. A method of operating an analog neural network comprising an input layer, a folded layer providing hidden layers such that at least two cycles of feeding back outputs and applying weights occur to complete all expected layers of the neural network, an output layer, a control circuit, and an analog memory, the method comprising:
generating, by the control circuit of the analog neural network, a write control signal, a read control signal, an input control signal, an output control signal, and a weight-change control signal, wherein the write control signal and the read control signal controllably couples the analog memory of the analog neural network as part of a feedback signal path to reuse circuitry of the folded layer, wherein the input control signal couples output of the input layer to the folded layer, wherein the output control signal couples a final output of the folded layer to the output layer, and the weight-change control signal controls application of weights to the folded layer.

20. The method of claim 19, wherein the input control signal and the output control signal have a period equal to a number of layers implemented by the folded layer and a pulse length of an amount of time taken to process a single layer, wherein the input control signal is high during a first layer of the hidden layers and low during other layers of the hidden layers, wherein the output control signal is high during a last layer of the hidden layers and low during other layers of the hidden layers;
wherein the write control signal provides a sampling frequency of a specified temporal quantization during at least the first layer of the hidden layers and is off during the last layer of the hidden layers; and
wherein the read control signal provides the sampling frequency of the specified temporal quantization during at least the last layer of the hidden layers and is off during the first layer of the hidden layers.
